(19) United States
(12) Patent Application Publication
(10) Pub. No.: US 2009/0001023 A1
(43) Pub. Date: Jan. 1, 2009

(54) Process for removing soluble and insoluble oxidation by-products from non-polar lubricating and hydraulic fluids

(76) Inventors: Peter E. Dufresne, Comox (CA); Gregory J. Livingstone, Tucson, AZ (US); David L. Wooton, Beaverdam, VA (US)

Correspondence Address: Barbara E. Johnson, Esq., 555 Grant Street, Suite 323, Pittsburg, PA, 15219, US

(21) Appl. No.: 12/152,446

(22) Filed: May 14, 2008

Related U.S. Application Data
(60) Provisional application No. 60/930,116, filed on May 14, 2007.

(51) Int. Cl. B01J 39/00

(52) U.S. Cl. 210/692

(57) ABSTRACT

A method of inserting into a non-polar fluid flow a quantity of a solid medium having porosity, preferably a crosslinked polystyrene resin, which absorbs or adsorbs oil oxidation by-products or other lubricant degradation products or varnish precursors dramatically to extend the life and performance of the lubricating oil.

### CROSS REFERENCE TO RELATED APPLICATIONS

This patent application claims priority to, and incorporates herein by reference, U.S. Provisional Patent Application No. 60/930,116 filed May 14, 2007.

### BACKGROUND OF THE INVENTION

1. Field of the Invention

The invention provides for the cleansing of hydrocarbon and other non-polar lubricants, such as turbine oil, hydraulic fluids or control oils, during use by the in-line introduction of a solid medium to remove soluble and insoluble oxidation by-products including depleted additive components and certain antioxidant radicals in the lubricant.

2. Description of Related Art

During previous years, electrostatic separation fluid maintenance systems have been extensively used in an attempt to remove oxidation by-products, which have been shown to cause “varnish” deposits in lubricating oil and hydraulic systems. The success of using electrostatic separation fluid maintenance systems for the removal of unwanted oxidation components in lubricating fluids such as turbine oil has had moderate success with older lubricant formulations, typically formulated with an API Group I basestock. This technology has also been proven to be successful at removal of oxidation by-products in low temperature applications or with fluids that have inorganic additive systems. However, electrostatic separation fluid maintenance systems' success at removing oxidation by-products, including certain depleted additive components and certain antioxidant radicals with modem lubricant formulations formulated with API Group II or III basestocks, has been much less successful. It is typical to observe preliminary success at removing oxidation by-products from the lubricant, with corresponding improvements in QSA® (QSA is a registered trademark of Analysts, Inc, Torrance, Calif.) values corroborating the initial results. However, it is common to see after 2-6 months the level of oxidation by-products return to their original levels. The ineffectiveness of electrostatic separation maintenance systems on modern lubricant formulations is even more pronounced when the antioxidant package has started to deplete. The inability of electrostatic separation technology to remove oxidation by-products in these situations means the formation of deposits like varnish occurs, along with a corresponding increase in QSA® values. The capital investment for electrostatic separation fluid maintenance systems to remove oxidation by-products in modern lubricants in certain applications, like large frame industrial gas turbines, may be without significant benefit.

Other technologies for extending the life of non-polar lubricating oils have included the in-line placement of particle filters, typically cellulose or synthetic polyester filters (resembling paper filters), to capture unwanted particulates together with the placement of in-line water removal modules for fluid conditioning. In a manner akin to renal dialysis in a patient, in-line filters and driers are placed in a fluid treatment loop through which, over time, all of the lubricant in a given system passes for treatment. These technologies have demonstrated tremendous benefits for increasing fluid performance, however they will not have an impact on the deposit-producing soluble or insoluble oil oxidation by-products. This impact of this invention not only removes harmful deposits that cannot be safely removed by any prior existing technology, but it also can dramatically increase the life and performance of lubricants. The convergence of increased oil prices and global ecological pressures makes this invention more pertinent than at any other time in history.

### SUMMARY OF THE INVENTION

In order to meet this need, the present invention is a method of contacting into a non-polar fluid flow a quantity of a solid porous medium, preferably a crosslinked polystyrene resin, which has the surprising effect of absorbing and/or adsorbing oxidation by-products and other related products of fluid degradation, When beads are used as the medium, the beads range from no. 16 to no. 50 mesh. The solid medium can be any of virgin cotton, activated carbon, mineral with ion exchange capacity (Clinoptilolite, Fuller's Earth and Zeolite), polystyrene polymers such as crosslinked styrene-divinylbenzene polymers arrayed as strong or weak anionic or cationic ion exchange medium or without any ion exchange functionality at all. A quantity of solid porous medium is generally placed in contact with the non-polar fluid in situ, either in-line directly, in-line in a fluid cleansing loop known in the art as a Kidney Loop or by any other means by which the solid medium and the fluid can be brought in contact. By replacing the solid medium as needed but not the lubricant itself, significantly extended lubricant life and increased fluid performance can be achieved. Any non-polar lubricating fluid in any setting (turbine lubricating oil, hydraulic oil, control oil or or others) may be cleaned by the present method.

### BRIEF DESCRIPTION OF THE DRAWING(S)

FIG. 1 is a sectional view of a replaceable cassette which retains a quantity of solid medium according to the invention, with a traditional cellulose or polyester filter positioned downstream.

### DESCRIPTION OF THE PREFERRED EMBODIMENT(S)

The present invention is a method of inserting into a non-polar fluid flow a quantity of a solid medium, preferably a crosslinked polystyrene resin, which has the surprising effect of absorbing or adsorbing both soluble and insoluble oil oxidation by-products and other lubricant degradation products to extend the life of the lubricating oil. The solid medium can be any of virgin cotton, activated carbon, mineral with ion exchange capacity (Clinoptilolite, Fuller's Earth and Zeolite), polystyrene polymers such as crosslinked styrene-divinylbenzene polymers arrayed as strong or weak anionic or cationic ion exchange medium or without any ion exchange functionality at all, with any or all media types generally having a porous structure. When beads are used as the medium the beads range from no. 16 to no. 50 mesh. The solid media may take the form of porous beads, or integral plugs or any other form including a sheet material (such as a filter sheet material) which is both solid and porous. A quantity of solid porous medium is typically placed in contact with the non-polar fluid in situ, in any mechanism for which the fluid serves as lubricant, either in-line directly, in-line in a fluid cleansing loop (analogous to renal dialysis in a medical setting) or by any other means by which the solid medium and the fluid can be brought in contact during ordinary use of the lubricant during operation. Any non-polar fluid in any setting, such as turbine lubricating oil, may be cleaned by the present method—dramatically to extend useful life of the fluid while only having to replace the solid medium.

### The Problem and Solution Described:

### Problem and Solution Discussion:

Understanding “useful oil life” in hydrocarbon lubricants or other non-polar fluids has been an area of some considerable debate if not confusion in the past. In a combustion engine setting, crankcase oil experiences varied assaults and contamination from products of combustion (POC), the close proximity of other fluids including engine coolant, soluble and insoluble degradation products and heavy doses of particulates both from POC as well as engine wear. In turbine oils and hydraulic and control oils, where POC is not ordinarily a problem, the predominant challenge to lubricant life is deposit formation due to oxidative and thermal reactions. Heretofore, however, varnish formation has not been well understood, and the removal of varnish precursors (oxidation by-products and other lubricant degradation products) in either soluble or insoluble forms elusive at best. The present inventors have, however, confirmed that varnish recurrence is directly related to a fluid chemical degradation process called “auto-degradation.”

When a lubricant undergoes auto-degradation, soft contaminants (oil degradation by-products) are formed after the fluid has been removed from service and is in a static and cool state. Soft contaminants are typically less than one micron in size and require specialized testing for their detection. A common test for determining varnish potential is the QSA® test. A similar test is currently being drafted under ASTM for the Measurement of Lubricant Generated Insoluble Color Bodies in In-Service Turbine Oils using Membrane Patch Colorimetry. The basics of the test are that a sample of oil is mixed with a solvent to accelerate the precipitation of the fluid degradation components and the mixed sample is then filtered on a membrane patch. The color of the patch is analyzed with a spectrophotometer; the darker the color of the patch, the more severe the varnish potential. The nature of the test is such that it is fairly easy to perform on site to the lubricant application. The best way to detect if a sample is undergoing auto-degradation is to draw a sample out of the lubricating or hydraulic fluid's system and perform a membrane patch test within 30 minutes of drawing the sample. The membrane patch test is then repeated on this isolated sample after an aging time of at least 72 hours. If the sample patches darken up considerably from the time when the sample was taken to 72 hours later, auto-degradation is occurring. Present analysis has shown that the occurrence of auto-degradation is related to the fluid antioxidant formulation and the fluid operating environment. There are two families of primary antioxidants used in many lubricating fluids such as turbine oils, the level of which can be measured by Linear Sweep Voltammetry (ASTM D6971). Auto-degradation begins once the phenols have depleted significantly, typically below about 25% compared to new oil.

The following points on auto-degradation can be summarized from the experiments that applicants have run and thus collected: a) auto-degradation begins when phenols from anti-oxidant additives have been depleted to around 25% of new—oils without phenolic antioxidants begin to auto-degrade more quickly than oils or other non-polar fluids containing phenolic antioxidants; b) addition of phenolic antioxidants usually does not completely stop auto-degradation; c) electrostatic separation technologies have little or no impact to reduce auto-degradation; and d) auto-degradation testing-experiment is reversible by heating the sample up to 150 degrees Fahrenheit for two hours, after which the soft contaminants re-dissolve into the lubricant.

In theory, therefore, although it is not intended to be bound by the theory, the present use of solid medium in non-polar lubricants during use removes the soluble contaminants that cause auto-degradation, thereby either preventing or removing soluble and insoluble oxidation by-products and varnish formation and increasing the oil (non-polar fluid) life significantly. Regardless of the mechanism of action of using solid porous medium in contact with non-polar lubricating fluids, the practical result remains that the use of solid porous media to reduce or eliminate oxidation by-products and consequently lubricant derived varnish deposits in lubricating oils and other non-polar fluids is a novel and nonobvious innovation.

### DETAILED DESCRIPTION OF THE INVENTION

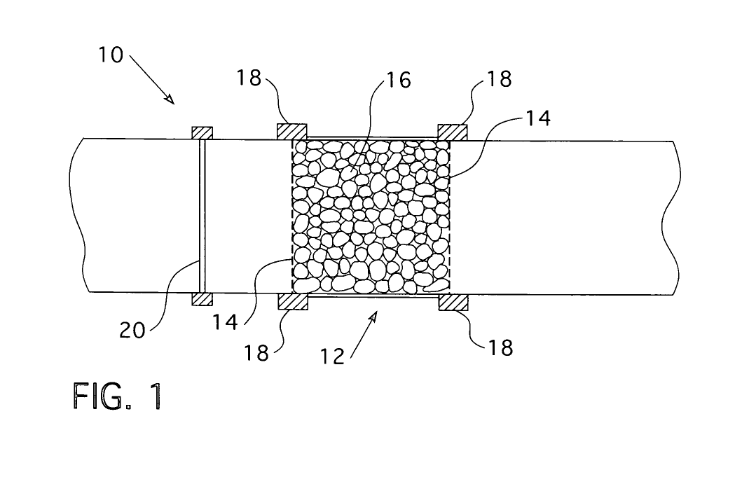

Referring now to FIG. 1, a sectional view of a portion of pipe 10 typical of a cleaning loop in a lubricant system is shown in section with a cassette 12 in place. The cassette 12 is a section of the pipe in which two barriers 14, typically a pored screen or mesh, are positioned both upstream and downstream of a quantity of porous beads 16 of solid medium according to the invention. The pores or mesh screen holes in the barrier 14 need only to be smaller than the smallest size of the beads 16 to hold them in their position within the cassette 12. The cassette 12 can be removed, for replacement of the beads 16, via threaded fasteners 18. A traditional particulate filter 20 is shown in position downstream of the cassette 12. The section of pipe 10 can be placed in any convenient location in a lubricant system, preferably in a location of easy access for maintenance (replacement of the solid medium beads).

Although in FIG. 1 the solid medium of the present invention is shown as a quantity of beads, the solid medium may take any form and still meet the present invention as disclosed and claimed herein. The beads may range from very small up to very large—media beads known in the art are adequate for use in the present systems or commercial beads can be subdivided if needed to fit smaller spaces. Alternatively, solid plugs of porous medium may be placed anywhere in the lubricant system where the medium will contact the non-polar lubricant fluid—this includes any other form including a sheet material—and these solid plugs can be replaced as needed just as cassettes or other containers of beads can be replaced or exchanged. Particulates of solid medium much finer than those shown in FIG. 1 may also be used as long as they are contained and do not circulate in the main body of the lubricant or other non-polar fluid. A central feature of the present invention is that the introduction of a solid porous medium will reduce or eliminate soluble or insoluble oxidation by-products or lubricant degradation products in non-polar fluids, and virtually any iteration of that idea will work.

As described above, solid medium for use in the present invention can be selected from the group consisting of virgin cotton, activated carbon, mineral with ion exchange capacity (Clinoptilolite, Fuller's Earth and Zeolite), and polystyrene polymers such as crosslinked styrene-divinylbenzene polymers, or any polystyrene polymers arrayed as strong or weak anionic or cationic ion exchange medium or without ion exchange functionality at all. The solid media can be any one of the above or two or more in combination. Whether used as beads or plugs or in some other form, the media will generally have a porous structure; when beads are used as the medium the beads range from no. 16 to no. 50 mesh. The preferred media therefore has a mesh size of 16-50.

It is believed, without intention of being bound by the theory, that the reason solid mediums were never before thought of for use to clean non-polar lubricants had to do with misunderstandings of the nature of the fluid degradation products and their interaction with said mediums heretofore. Some petroleum experts believed that hydrocarbon lubricants had a natural “oil life” which could never be extended no matter how clean the oil could be theoretically kept, possibly due to shear effects or irreversible chemical degradation that was simply generally accepted as inevitable. Separately, some of the solid media useful in the present invention would be counterintuitive to place in a hydrocarbon system due to their water content. Ion exchange resins, for example, have been used to reduce acid content in phosphate ester lubricants where the presence of the water in the ion exchange resin actually enhances the desired ion-exchange or ion-based bonding which occurs. In the present invention, however, hydrocarbon or other non-polar lubricants can accommodate only minimal amounts of water-turbine oils in particular. One skilled in the art would not think to combine a hydrocarbon or other non-polar lubricant with an ion exchange resin or other material having a commercial water content without having consulted the present specification. Furthermore, ion exchange processes depend upon a material's ability to respond to electrical charges and it has been thought that ionic processes cannot occur in non-polar fluids. Having said that, however, commercial solid media that do contain water (such as but not limited to the present polystyrene materials particularly when they contain ion exchange capacity) can simply have their water content reduced, by means known in the art, prior to introduction into the non-polar lubricant system, and/or additional in-line driers (known in the art) can be added to the system to remove the excess water.

In the practice of the present invention, the use of the solid porous media reduces lubricant (or other fluid) QSA® values at least to 15, more preferably to 10 QSA®, and most preferably to 5 QSA®. In other words, the practice of the present method reduces non-polar fluid QSA® to 15 or lower, more preferably to 10 or lower and most preferably to 5 or lower which is the level of most new oils.

Some of the solid media listed above remove more than the oxidation by-products or lubricant degradation products responsible for creating varnish and other challenges to lubricant life. For example, the use of Fuller's Earth would remove virtually all the additives in the oil that are placed there deliberately by the manufacturer—the detergents, dispersants, anti-oxidants and rust inhibitors that are all there to accommodate well known oil contamination challenges. However, with the prospect of increasing oil life considerably, this excessive-additive-removal phenomenon can be overcome—by for example reintroducing the additives after (downstream of) treating the oil to remove the constituents removable with the present media. Importantly, crosslinked polystyrene (whether containing strong or weak anion or cation exchange functionality or no ion exchange functionality at all) is believed to remove only the soluble oil oxidation by-products, degraded additives and certain antioxidant radicals that cause deposits, without removing the other additive components found in in-service lubricating oils such as anti-oxidants (or any of the many additives in oil). For at least this reason, the crosslinked polystyrene solid media of the present invention is preferred.

It should be understood that the configuration of FIG. 1 is for most installations not shown to scale. Turbine lubricant applications can contain from 200 to 20,000 gallons of lubricant, typically, or even less or more than that, and the associated media needed according to the invention increases or decreases proportionately. The present invention thus accommodates a wide variety of media amounts and fluid systems, and those skilled in the art learning from this specification to use the disclosed media to remove soluble and insoluble oil oxidation by-products, lubricant degradation products and other contaminants from lubricating oils will easily be able without undue experimentation to determine how much media to use and how often to replace it. Having said that, however, a typical installation for turbine lubricant could include two cassettes 1 foot in diameter and 20 inches in length containing typical crosslinked divinylbenzene polystyrene ion exchange media beads to treat 6,000 gallons of lubricating oil in situ.

Although the invention has been described with particularity above, with reference to a Figure and particular materials and theories, the invention is only to be limited insofar as is set forth in the accompanying claims.

We claim:

1. A method of removing unwanted compounds from a quantity of non-polar lubricant, comprising the step of inserting into a non-polar fluid a quantity of a solid medium able to absorb or adsorb said unwanted compounds

2. The method according to claim 1, wherein said solid medium is at least one of the media selected from the group consisting of virgin cotton, activated carbon, Clinoptilolite, Fuller's Earth, Zeolite, and polystyrene and the solid medium has porosity.

3. The method according to claim 2 wherein said polystyrene is crosslinked.

4. The method according to claim 3 wherein said polystyrene has ion exchange capacity.

5. The method according to claim 4 wherein the polystyrene media is crosslinked divinylbenzene polystyrene.

6. The method according to claim 5 wherein the polystyrene media is in bead form and the beads range from no. 16 to no. 50 mesh.

7. The method of claim 6 wherein the non-polar lubricant is a hydrocarbon oil and wherein the method reduces the QSA® of said hydrocarbon oil to 15 or lower.

8. The method of claim 7 wherein the non-polar lubricant is a turbine lubricating oil and the method reduces the QSA® of said hydrocarbon oil to 10 or lower.

9. The method of claim 7 wherein the non-polar lubricant is a hydraulic oil, control oil or other lubricating oil.

10. The method of claim 7 wherein the bead form polystyrene media is contained within a cassette and wherein the method reduces the QSA® of said hydrocarbon oil to 5 or lower.
